(19) United States
(12) Patent Application Publication
(10) Pub. No.: US 2020/0121549 A1
(43) Pub. Date: Apr. 23, 2020

(54) MASSAGE MACHINE

(71) Applicant: FAMILY INADA CO., LTD., Osaka (JP)

(72) Inventors: Nichimu Inada, Osaka (JP); Ryo Kawakami, Tottori (JP)

(21) Appl. No.: 16/654,594

(22) Filed: Oct. 16, 2019

(30) Foreign Application Priority Data
Oct. 18, 2018 (JP) 2018-196484

(51) Int. Cl. A61H 15/00; A61H 7/00

(52) U.S. Cl. CPC A61H 15/0078; A61H 7/007; A61H 2205/081; A61H 2015/005; A61H 2201/1418; A61H 2201/0149

(57) ABSTRACT

The massage machine includes a massage unit for treating a treatment target person, a first drive unit for driving the massage unit in a direction facing a treatment site of at least the treatment target person, and a control unit that controls driving of at least the first drive unit. The massage unit is configured to include a treatment unit in an articulated structure with at least two or more joints, and a second drive unit that drives the treatment unit in the direction facing the treatment target site of the treatment target person. The at least the two or more joints are shifted from each other in a direction intersecting a longitudinal direction of the treatment target site.

### TECHNICAL FIELD

The present invention relates to a massage machine.

### BACKGROUND ART

In the related art, a massage apparatus has been proposed which has a massage unit provided with a plurality of link members, an operating-purpose air cell for operating the link members, a massage-purpose air cell, and a spring (coil spring) serving as an elastic member.

The massage apparatus disclosed in Japanese Patent Application Publication No. JP-2016-101475-A includes the massage unit that has a first member and a second member which are disposed along a circumferential direction of a body part of a treatment target person, and in which one side of a space formed between the first member and the second member is open so as to allow free access of the body part. The massage unit further includes the air cell disposed together with the first member and inflated so as to press the body part, and a massage mechanism that performs an operation for relatively moving the first member and the second member close to each other, and an operation for moving the inflated air cell and the first member in a direction of at least one side between an opening side of the space and a side opposite thereto. A motion of a human hand is reproduced by the massage unit configured as described above. However, a motion of human wrist is not reproduced by the massage unit.

### SUMMARY OF THE INVENTION

According to one of the aspects of the present invention, a massage machine includes a massage unit configured to treat a treatment target person, a first drive unit that drives the massage unit at least in a direction facing a treatment target site of the treatment target person, and a control unit that controls driving of at least the first drive unit. The massage unit includes a treatment unit in an articulated structure with at least two or more joints, and a second drive unit that drives the treatment unit at least in the direction facing the treatment target site. The at least the two or more joints are shifted from each other in a direction intersecting a longitudinal direction of the treatment target site.

In addition, it is preferable that a pair of the right and left massage units is disposed so as to pinch the treatment target site of the treatment target person. The first drive unit may be capable of driving the massage unit in a direction extending along the treatment target site.

The first drive unit may have a motor, a drive shaft that transmits a rotational movement of the motor, and a conversion member that converts the rotational movement of the drive shaft into an oscillating movement of the treatment unit.

In addition, the treatment unit may include an outer treatment unit located relatively outward and an inner treatment unit located relatively inward. The second drive unit may include a second outer drive unit that drives the outer treatment unit, and a second inner drive unit that drives the inner treatment unit.

According to the present invention, the motion of the human hand and the motion of the human wrist may be reproduced.

### BRIEF DESCRIPTION OF THE DRAWINGS

FIG. 1 is a front perspective view of a massage machine according to an embodiment of the present invention.

FIG. 2 is a schematic view of the massage machine according to the embodiment of the present invention.

FIG. 3 is a functional block diagram of the massage machine.

FIG. 4 is a front perspective view of an arm massage unit disposed in a right side armrest unit.

FIG. 5 is a front view of a cross section in which the arm massage unit disposed in the right side armrest unit is cut by a plane A.

FIG. 6 is a schematic view of the arm massage unit disposed in the right side armrest unit, and illustrates a state where a second outer drive unit and a second inner drive unit are driven.

FIG. 7 is a schematic view of the arm massage unit disposed in the right side armrest unit, and illustrates a state where the second outer drive unit is driven.

FIG. 8 is a schematic view of the arm massage unit disposed in the right side armrest unit, and illustrates a state where the second inner drive unit is driven.

FIGS. 9A and 9B are views in which a joint is omitted from the right side arm massage unit in a first state. FIG. 9A is a front view, and FIG. 9B is a plan view.

FIGS. 10A and 10B are views in which the joint is omitted from the right side arm massage unit in a second state. FIG. 10A is a front view, and FIG. 10B is a plan view.

FIGS. 11A and 11B are views in which the joint is omitted from the right side arm massage unit in a third state. FIG. 11A is a front view, and FIG. 11B is a plan view.

FIGS. 12A and 12B are views in which the joint is omitted from the right side arm massage unit in a fourth state. FIG. 12A is a front view, and FIG. 12B is a plan view.

FIG. 13 is a flowchart illustrating an action pattern of the arm massage unit.

FIG. 14 is a schematic view of an arm massage unit according to another embodiment of the present invention, and illustrates the arm massage unit provided so that one treatment unit can perform massage in an upward-downward direction and the other treatment unit can perform massage in a rightward-leftward direction.

### DETAILED DESCRIPTION OF THE INVENTION

### Configuration of Massage Machine According to Embodiment

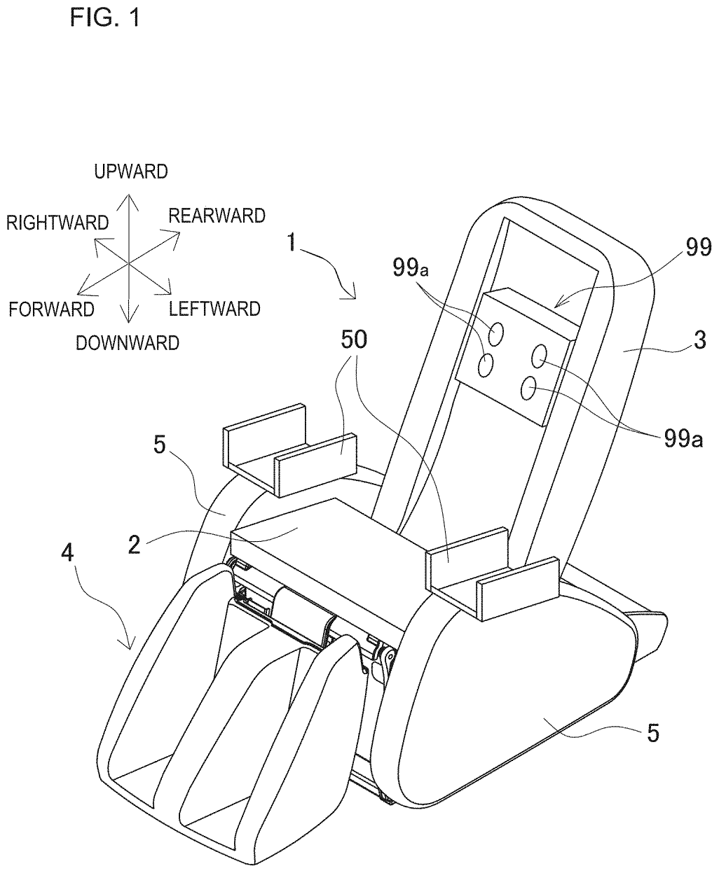

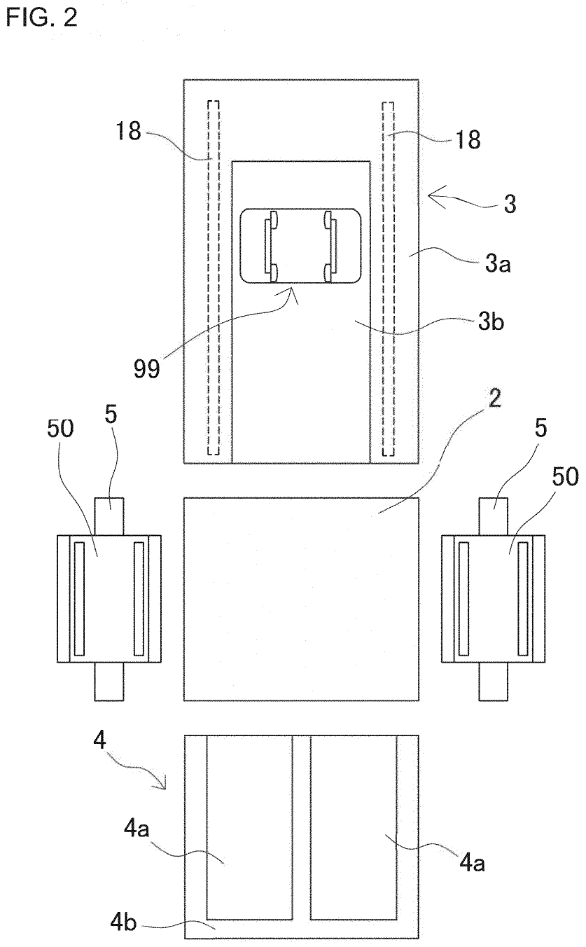

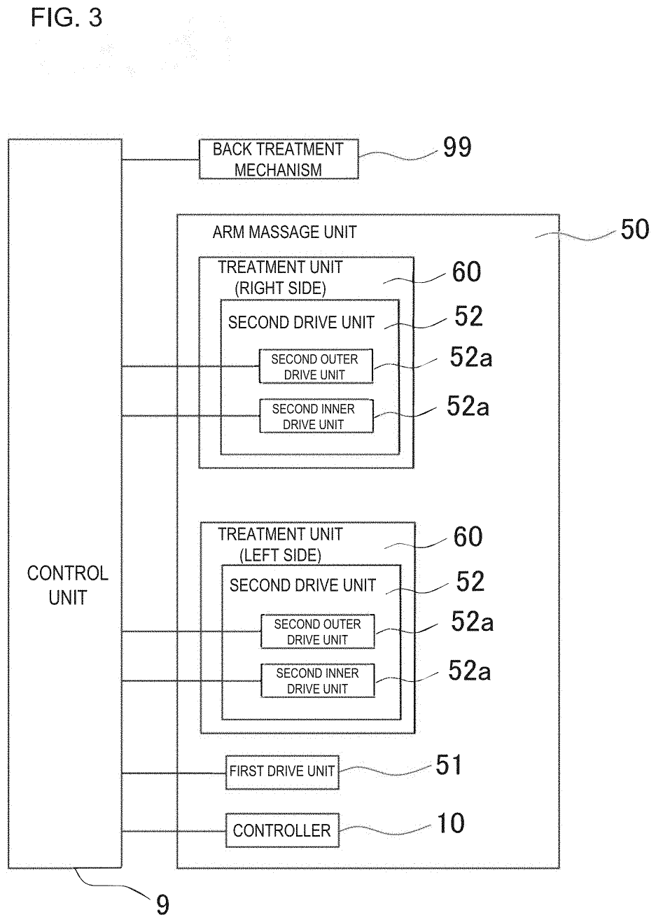

Hereinafter, an overall configuration of a massage machine 1 according to an embodiment of the present invention will be described. FIG. 1 is a front perspective view of the massage machine 1 according to the embodiment of the present invention. FIG. 2 is a schematic view of the massage machine 1 according to the embodiment of the present invention. FIG. 3 is a functional block diagram of the massage machine 1.

A concept of directions used in the following description coincides with a concept of directions when viewed from a treatment target person sitting on the massage machine 1 illustrated in FIG. 1. In other cases, the concept will be appropriately described. In addition, description will be made as follows. In a case of simply describing the inside or the outside, a side close to the treatment target person will be referred to as the inside in a rightward-leftward direction, and a side opposite thereto will be referred to as the outside.

### Overall Configuration of Massage Machine

As illustrated in FIGS. 1 to 3, the massage machine 1 according to the embodiment of the present invention mainly has a seat unit 2 on which the treatment target person sits, a backrest unit 3 disposed in a rear part of the seat unit 2 so as to be capable of reclining and against which the treatment target person leans, a footrest 4 disposed in a front part of the seat unit 2 disposed so as to be capable of oscillating upward and downward and supporting lower limbs of the treatment target person, and armrest units 5 respectively disposed on both right and left sides of the seat unit 2. The seat unit 2, the backrest unit 3, the footrest 4, and the armrest unit 5 function as body support units that support a body of the treatment target person. The massage machine 1 has a back treatment mechanism 99 that performs kneading massage and/or tapping massage by using the backrest unit 3, an arm massage unit 50 serving as a massage unit that performs massage by pinching an arm of the treatment target person, a control unit 9 that controls each operation of the massage machine 1, and a controller 10 that allows the treatment target person to perform various operations (to be described later).

In the present embodiment, a case of the arm massage unit 50 in which the massage unit is disposed in the armrest unit 5 will be described.

The control unit 9 has a programmable microcomputer, and performs drive control on the back treatment mechanism 99, the treatment unit 60 configuring the arm massage unit 50, the first drive unit 51 for driving the arm massage unit 50. The control unit 9 is electrically connected to the controller 10 (to be described later). The massage machine 1 operates the back treatment mechanism 99 and the arm massage unit 50 in accordance with a predetermined program (massage course) stored in the control unit 9, and further, is operated in accordance with an instruction from the controller 10 which is input by the treatment target person (to be described later).

### Configuration of Seat Unit

As illustrated in FIGS. 1 to 3, the footrest 4 (to be described later) is attached to a front side of the seat unit 2 via an oscillating shaft (not illustrated) so as to be capable of freely oscillating with respect to the seat unit 2 in an upward-downward direction. In addition, the backrest unit 3 (to be described later) is attached to a rear side of the seat unit 2 via an oscillating shaft (not illustrated) so as to be capable of freely reclining with respect to the seat unit 2 in a forward-rearward direction. In addition, the armrest units 5 are respectively attached to both right and left sides of the seat unit 2.

Although not illustrated, a massage unit for performing massage on a gluteal region and/or a femoral region of the treatment target person may be disposed in the seat unit 2.

### Configuration of Backrest Unit

As illustrated in FIGS. 1 to 3, the backrest unit 3 is configured to include a rigid back frame 3a, a guide rail 18 that guides ascending/descending of the back treatment mechanism 99 assembled to the back frame 3a, and a cover member (not illustrated) that covers the back frame 3a. The back frame 3a has an opening 3b which is formed at the center in the rightward-leftward direction and which is open in the forward-rearward direction, and has a substantially portal shape in a front view. In addition, the cover member (not illustrated) is attached to a front portion of the opening 3b so as to cover the opening 3b. A treatment element 99a (refer to FIG. 1) of the back treatment mechanism 99 protrudes forward from the opening 3b, and can perform massage on the body of the treatment target person from the rear side via the cover member (not illustrated). For example, the back treatment mechanism 99 has four kneading balls. The back treatment mechanism 99 performs massage on a back of the treatment target person by using the kneading balls while moving upward and downward along the guide rail 18.

### Configuration of Footrest

As illustrated in FIGS. 1 to 3, the footrest 4 has a pair of right and left grooves 4a respectively supporting lower thighs of the treatment target person, and a pair of right and left foot plates 4b respectively supporting feet of the treatment target person. The groove 4a of the footrest 4 extends downward when viewed from the seat unit 2. Although not illustrated, a massage unit for performing massage on the lower thigh and/or the foot of the treatment target person may be disposed in each location of the groove 4a and the foot plate 4b.

### Configuration of Controller

As illustrated in FIG. 3, the controller 10 is connected to the control unit 9. The treatment target person can change a posture of the backrest unit 3 or a posture of the footrest 4 by operating the controller 10. In addition, the treatment target person can select the back treatment mechanism 99 and the arm massage unit 50 to be operated, or can change each operation (procedure or strength) of the back treatment mechanism 99 and the arm massage unit 50.

### Configuration of Armrest Unit

As illustrated in FIGS. 1 and 2, each of a pair of the armrest units 5 is provided on both right and left sides of the seat unit 2. The armrest unit 5 extends upward from the seat unit 2. The arm massage unit 50 (to be described later) is attached to an upper portion of the armrest unit 5. The treatment target person can receive the massage for the arm by laying the arm on the arm massage unit 50.

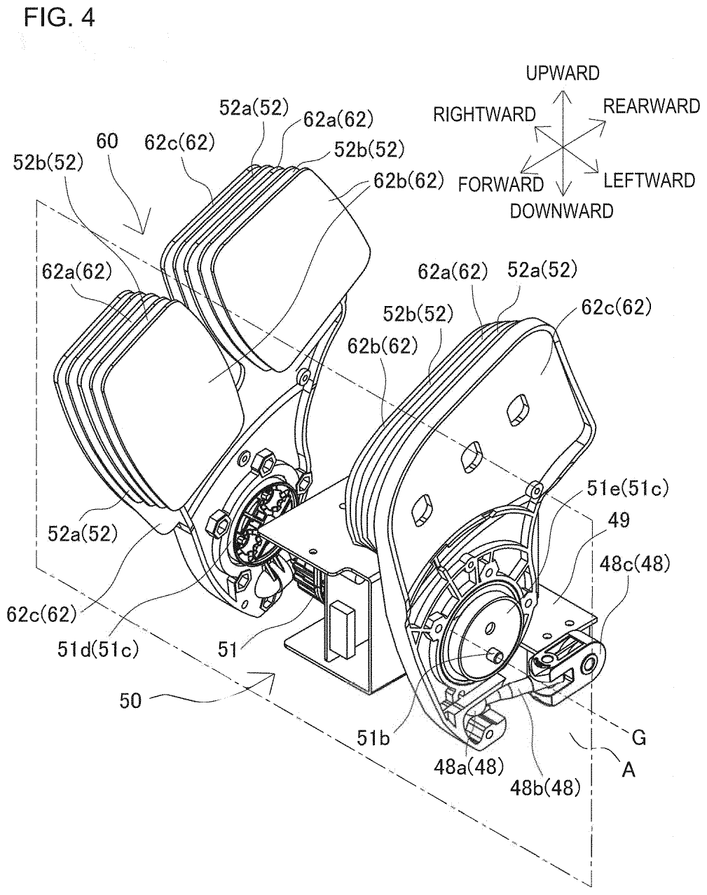

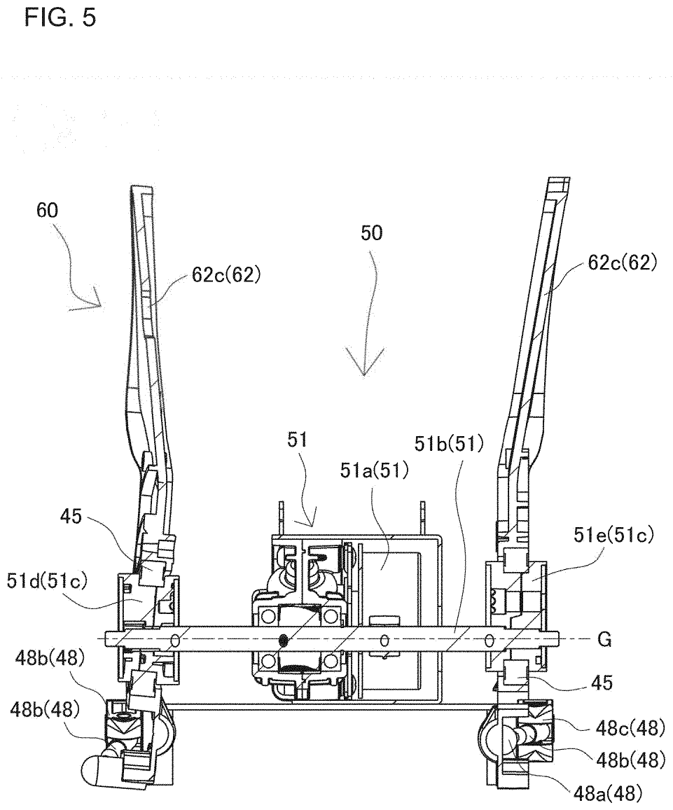

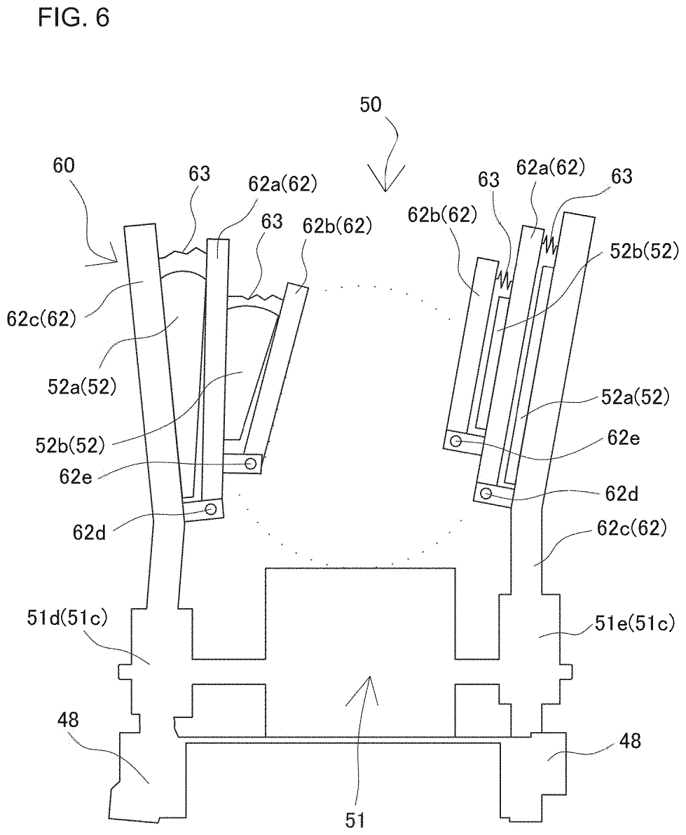

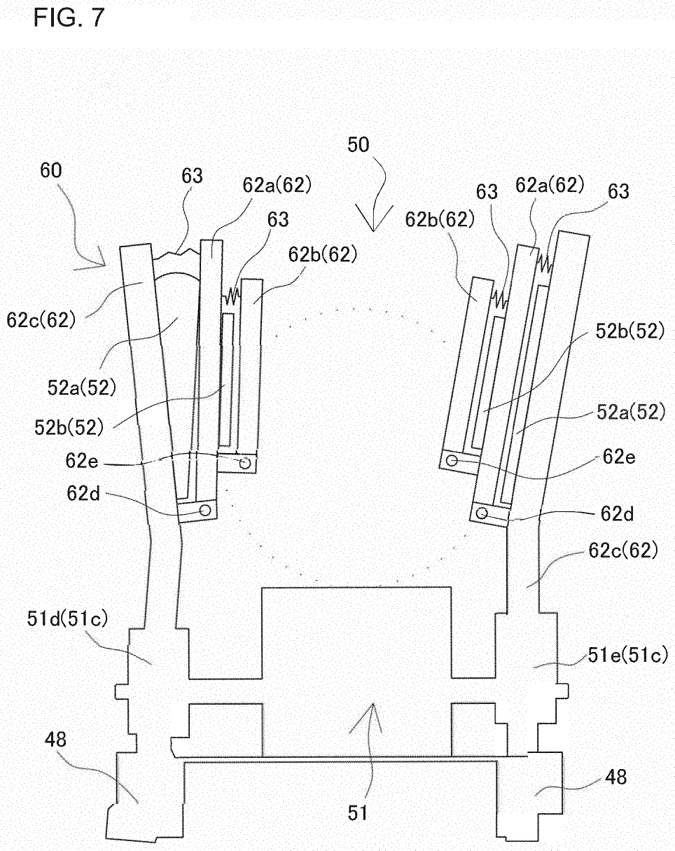

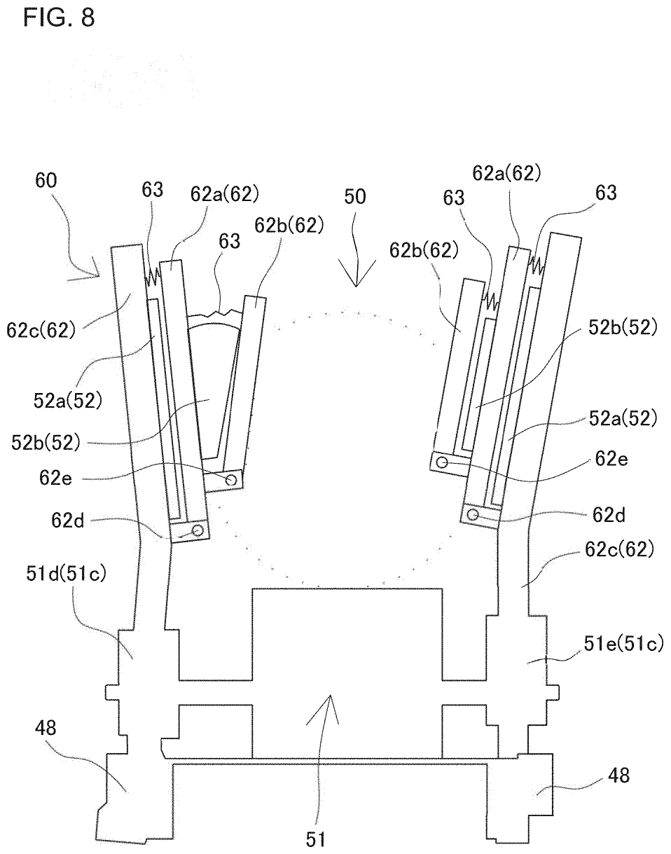

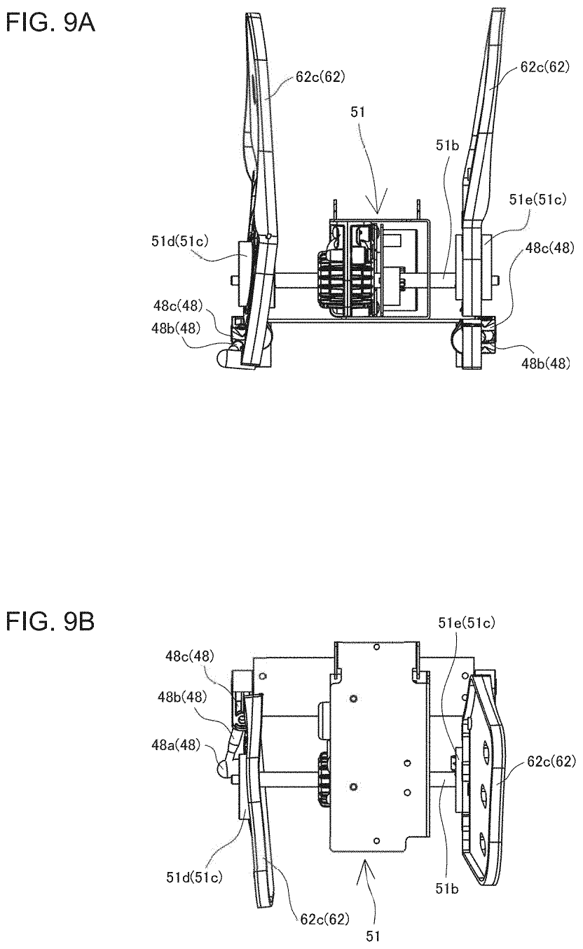

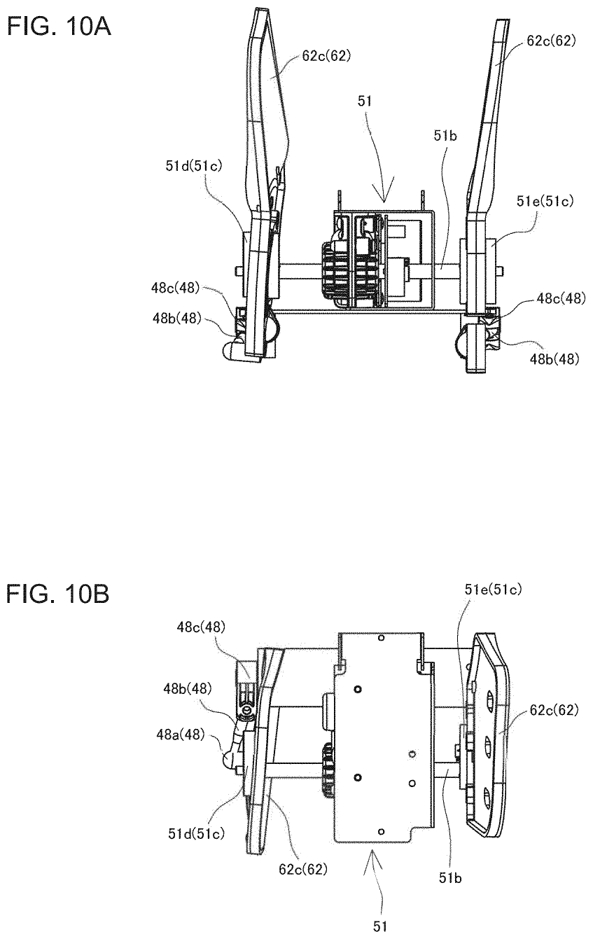

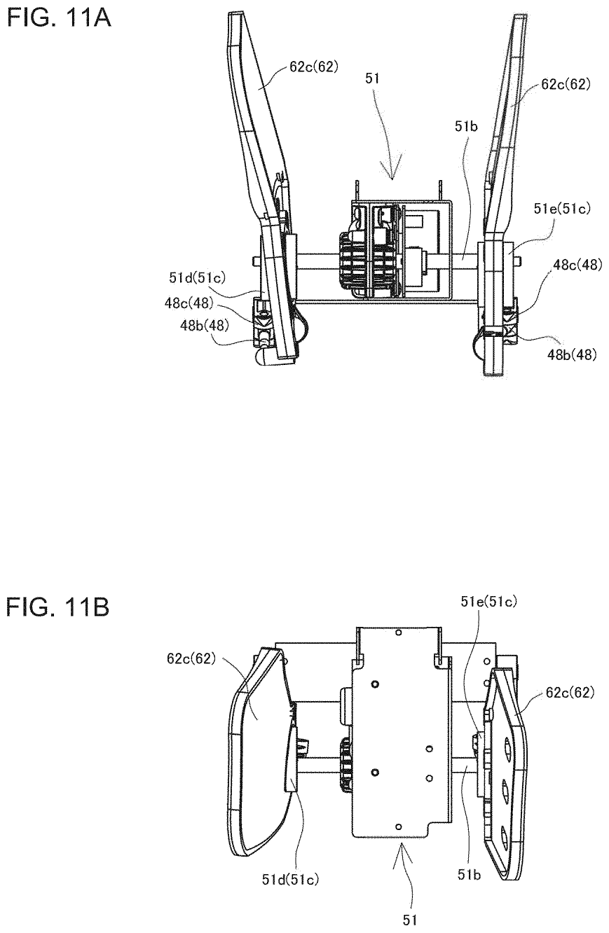

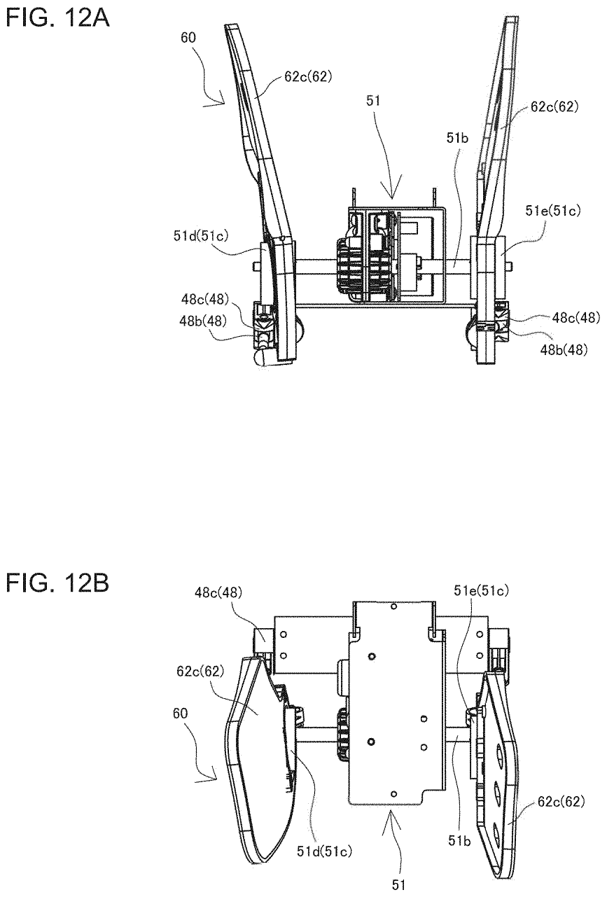

FIG. 4 is a front perspective view of the arm massage unit 50 disposed in the right side armrest unit 5. FIG. 5 is a front view of a cross section in which the arm massage unit 50 disposed in the right side armrest unit 5 is cut by a plane A. FIG. 6 is a schematic view of the arm massage unit 50 disposed in the right side armrest unit 5, and illustrates a state where a second outer drive unit 52a and a second inner drive unit 52b are driven. FIG. 7 is a schematic view of the arm massage unit 50 disposed in the right side armrest unit 5, and illustrates a state where the second outer drive unit 52a is driven. FIG. 8 is a schematic view of the arm massage unit 50 disposed in the right side armrest unit 5, and illustrates a state where the second inner drive unit 52b is driven. FIGS. 9A and 9B are views in which a joint 62 is omitted from the right side arm massage unit 50 in a first state. FIG. 9A is a front view, and FIG. 9B is a plan view. FIGS. 10A and 10B are views in which the joint 62 is omitted from the right side arm massage unit 50 in a second state. FIG. 10A is a front view, and FIG. 10B is a plan view. FIGS. 11A and 11B are views in which the joint 62 is omitted from the right side arm massage unit 50 in a third state. FIG. 11A is a front view, and FIG. 11B is a plan view. FIGS. 12A and 12B are views in which the joint 62 is omitted from the right side arm massage unit 50 in a fourth state. FIG. 12A is a front view, and FIG. 12B is a plan view.

### Configuration of Arm Massage Unit

Hereinafter, a configuration of the right side arm massage unit 50 will be described. The left side arm massage unit 50 has the same configuration as the right side arm massage unit 50, and thus, description thereof will be omitted.

As illustrated in FIGS. 3 to 12B, the arm massage unit 50 is configured to include a first drive unit 51 for driving the arm massage unit 50 in a direction facing a treatment target site of at least the treatment target person and a direction extending along the treatment target site, a treatment unit 60 including an articulated structure having at least two or more joints, and a second drive unit 52 for driving the treatment unit 60 in a direction facing the treatment target site of at least the treatment target person. In addition, a pair of the right and left arm massage units 50 is disposed so as to pinch the treatment target site of the treatment target person.

### Configuration of Treatment Unit

As illustrated in FIGS. 3 to 12, the treatment unit 60 includes the articulated structure having at least two or more joints 62. The treatment unit 60 has an outer treatment unit 62a disposed to face the treatment target site of the treatment target person and located relatively outward, and an inner treatment unit 62b located relatively inward. The outer treatment unit 62a and the inner treatment unit 62b are configured to include a plate-shaped member.

### Configuration of First Drive Unit

As illustrated in FIG. 5, the first drive unit 51 has a motor 51a, a drive shaft 51b that transmits a rotational movement of the motor 51a to a treatment plate 62c (to be described later), and a conversion member 51c that converts the rotational movement of motor 51a which is transmitted from the drive shaft 51b into an oscillating movement of the treatment plate 62c. The conversion member 51c is an eccentric deflection angle cam 51d for causing the treatment plate 62c to oscillate in upward-downward direction and the rightward-leftward direction, and an eccentric cam 51e for causing the treatment plate 62c to oscillate in the upward-downward direction and the forward-rearward direction.

In the present embodiment, the conversion member 51c attached to the treatment plate 62c located outside the arm is configured to include the eccentric deflection angle cam 51d, and the conversion member 51c attached to the treatment plate 62c located inside the arm is configured to include the eccentric cam 51e.

The conversion member 51c may be any member that can convert the rotational movement of the motor 51a which is transmitted from the drive shaft 51b into the oscillating movement of the treatment plate 62c. For example, the conversion member 51c of the treatment plate 62c located relatively outward may be configured to include the eccentric cam 51e, and the conversion member 51c of the treatment plate 62c located relatively inward may be configured to include the eccentric deflection angle cam 51d. In addition, the conversion member 51c of the treatment plate 62c located relatively outward and the conversion member 51c of the treatment plate 62c located relatively inward may be configured to include the eccentric deflection angle cam 51d.

According to this configuration, the treatment plate 62c can three-dimensionally move. Therefore, it is possible to reproduce the motion of the human wrist.

### Configuration of Joint

As illustrated in FIGS. 6 to 8, at least two or more joints 62 configuring the treatment unit 60 are configured to include the outer treatment unit 62a located relatively outward, the inner treatment unit 62b located relatively inward, and the treatment plate 62c to which the outer treatment unit 62a and the inner treatment unit 62b are attached. The number of the joints 62 may be at least two or more.

In the embodiment, two joints 62 are provided. In addition, the respective joints 62 are shifted from each other in a direction intersecting a longitudinal direction of the treatment target site of the treatment target person. A plurality of the joints 62 are shifted from each other in a direction orthogonal to the longitudinal direction of the treatment target site of the treatment target person. In this manner, it is possible to reproduce the fingers of the human hand. In the present embodiment, the plurality of joints 62 are shifted from each other for the treatment target site in the upward-downward direction.

The outer treatment unit 62a is attached to the treatment plate 62c via an outer oscillating shaft 62d so as to freely oscillate. A biasing member 63 (to be described later) is attached between an upper portion of the outer treatment unit 62a and an upper portion of the treatment plate 62c. The outer treatment unit 62a is biased by the biasing member 63 in a direction closer to the treatment plate 62c (direction away from the treatment target site of the treatment target person.

The inner treatment unit 62b is attached to the outer treatment unit 62a via an inner oscillating shaft 62e so as to freely oscillate. The biasing member 63 (to be described later) is attached between an upper portion of the inner treatment unit 62b and an upper portion of the outer treatment unit 62a. The inner treatment unit 62b is biased by the biasing member 63 in a direction closer to the outer treatment unit 62a (direction away from the treatment target site of the treatment target person).

The treatment plate 62c is located outside the outer treatment unit 62a. The treatment plate 62c is configured to include the plate-shaped member. The treatment plate 62c extends upward. The treatment plate 62c is curved to be inclined with respect to the first drive unit 51 outward from the vicinity of the center (refer to FIG. 5). The first drive unit 51 is attached to the lower portion of the treatment plate 62c via the conversion member 51c. As illustrated in FIG. 4, in the present embodiment, the treatment plate 62c located outward is configured to include a substantially Y-shaped and plate-shaped member having bifurcated tip portions. The outer treatment unit 62a and the inner treatment unit 62b are attached to the respective tip portion. In addition, the treatment plate 62c located inward is configured to include a substantially L-shaped and plate-shaped member extending rearward.

According to this configuration, the treatment plate 62c located outward can reproduce the four fingers of the human hand, and the treatment plate 62c located inward can reproduce the thumb of the human hand.

### Configuration of Second Drive Unit

As illustrated in FIGS. 4 and 6 to 8, the second drive unit 52 is configured to include an air cell. The second drive unit 52 is configured to include the second outer drive unit 52a located relatively outward and the second inner drive unit 52b located relatively inward. The second outer drive unit 52a and the second inner drive unit 52b can be driven independently of each other. The second drive unit 52 is driven, thereby enabling the joint 62 biased by the biasing member 63 to oscillate in a direction closer to the treatment target site of the treatment target person.

According to this configuration, the motion of at least two or more joints configuring the treatment unit 60 can be smooth. Accordingly, the motion of the joints can be closer to the motion of the fingers of the human hand.

### Configuration of Biasing Member

As illustrated in FIGS. 6 to 8, the joint 62 has the biasing members 63 for biasing the treatment unit 60 in a direction away from the treatment target site of the treatment target person. Specifically, one biasing member is disposed between the upper portion of the treatment plate 62c and the upper portion of the outer treatment unit 62a, and one biasing member is disposed between the upper portion of the outer treatment unit 62a and the upper portion of the inner treatment unit 62b.

The biasing member 63 is configured to include a tension spring. The biasing member 63 biases the joint 62 in the direction away from the treatment target site of the treatment target person. The second drive unit 52 is turned on or off to be driven, thereby enabling the joint 62 to move close to or to move away from the treatment target site of the treatment target person. That is, when the second drive unit 52 is not in a driven state, the joint 62 can be prevented from coming into contact with the treatment target site. In addition, a motion of pulling/kneading performed by the human hand can be reproduced by being combined with the driving of the second drive unit 52.

In the present embodiment, the biasing member 63 is configured to include the tension spring. However, without being limited to the above-described configuration, any configuration may be adopted as long as the treatment unit 60 can be biased in the direction away from the treatment target site of the treatment target person. For example, a double torsion spring may be adopted. In this case, the motion of pulling/kneading can be realized by attaching the double torsion spring to the outer oscillating shaft 62d or the inner oscillating shaft 62e.

An operation of the conversion member 51c will be described. As illustrated in FIGS. 9A to 12B, the drive shaft 51b has a rotation axis G (refer to FIG. 5) that is a rotation axis extending along the rightward-leftward direction. The conversion members 51c are respectively attached to both end portions of the drive shaft 51b in the rightward-leftward direction. The attached conversion members 51c are different from each other on the right and left sides. The conversion member 51c located relatively outward is the eccentric deflection angle cam 51d. The conversion member 51c located relatively inward is the eccentric cam 51e. The drive shaft 51b is rotated in proportion to the rotation speed of the motor 51a.

The conversion member 51c has a bearing 45 (refer to FIG. 5) and a link mechanism 48 which regulates an operation range in the rotation direction of the conversion member 51c attached to the treatment plate 62c to fall within a predetermined range so that the treatment plate 62c is not rotated by the rotation of the drive shaft 51b and which allows the treatment plate 62c to be operated in the axial direction of the rotation axis G of the drive shaft 51b.

As illustrated in FIG. 4, the link mechanism 48 has a spherical end portion 48a, a first member 48b that can pivot in the rightward-leftward direction, and a second member 48c that can pivot in the upward-downward direction. The end portion 48a is connected to the lower portion of the treatment plate 62c by using a ball joint method with a spherical hole. The second member 48c is pivotally supported by a support member 49.

An operation in a case where the conversion member 51c is the eccentric cam 51e will be described. As illustrated in FIG. 5, the axis of the eccentric cam 51e is attached to the rotation axis G of the drive shaft 51b while being shifted therefrom. The treatment plate 62c is interlocked with the link mechanism 48.

If the drive shaft 51b is rotated, the rotational movement of the drive shaft 51b is transmitted to the treatment plate 62c via the link mechanism 48. The treatment plate 62c is interlocked with the link mechanism 48. Accordingly, the treatment plate 62c can oscillate in the forward-rearward direction and the upward-downward direction with respect to the drive shaft 51b without being rotated in synchronization therewith.

An operation in a case where the conversion member 51c is the eccentric deflection angle cam 51d will be described. As illustrated in FIG. 5, the rotation axis of the eccentric deflection angle cam 51d is attached to the rotation axis G while being inclined therefrom. The treatment plate 62c is interlocked with the link mechanism 48.

If the drive shaft 51b is rotated, the rotational movement of the drive shaft 51b is transmitted to the treatment plate 62c via the link mechanism 48. The treatment plate 62c is interlocked with the link mechanism 48. Accordingly, the treatment plate 62c can oscillate in the forward-rearward direction and the rightward-leftward direction and upward-downward direction with respect to the drive shaft 51b without being rotated in synchronization therewith.

As illustrated in FIGS. 9A to 12B, the arm massage unit 50 oscillates in synchronization with the oscillation of the conversion member 51c. The right and left treatment plates 62c oscillate by driving the first drive unit 51.

An oscillating operation of the outer treatment plate 62c will be described. The outer treatment plate 62c is attached via the eccentric deflection angle cam 51d. If the first drive unit 51 is driven, as illustrated in FIGS. 9A and 9B, the treatment plate 62c reaches an innermost (right side) position (hereinafter, referred to as a first state). Subsequently, if the first drive unit 51 is driven, as illustrated in FIGS. 10A and 10B, the treatment plate 62c moves to an uppermost position and rearward to the left side, compared to the first state (hereinafter referred to as a second state). Subsequently, if the first drive unit 51 is driven, as illustrated in FIGS. 11A and 11B, the treatment plate 62c is located at an outermost (left side) position and at a lower position compared to the second state in the upward-downward direction, and moves forward, compared to the first state and the second state (hereinafter, referred to as a third state). Subsequently, if the first drive unit 51 is driven, as illustrated in FIGS. 12A and 12B, the treatment plate 62c moves to a lowermost position and rightward, compared to the third state (hereinafter, referred to as a fourth state). Compared to the first state, the treatment plate 62c is located at a lower position in the upward-downward direction, and moves rightward. The fourth state moves forward compared to the third state. The fourth state is a state where the treatment plate 62c is located in a foremost end in an oscillating range of the treatment plate 62c.

An oscillating operation of the inner treatment plate 62c will be described. The inner treatment plate 62c is attached via the eccentric cam 51e. If the first drive unit 51 is driven, as illustrated in FIGS. 9A and 9B, the treatment plate 62c reaches a highest position (hereinafter, referred to as the first state). Subsequently, if the first drive unit 51 is driven, as illustrated in FIGS. 10A and 10B, the treatment plate 62c moves most rearward and to a lower position, compared to the first state (hereinafter referred to as the second state). Subsequently, if the first drive unit 51 is driven, as illustrated in FIGS. 11A and 11B, the treatment plate 62c moves to a lowest position and forward, compared to the second state (hereinafter, referred to as the third state). Subsequently, if the first drive unit 51 is driven, as illustrated in FIGS. 12A and 12B, the treatment plate 62c is moved most forward and to a higher position, compared to the third state (hereinafter, referred to as the fourth state).

In this way, the arm massage unit 50 performs massage on the human body by driving the second drive unit 52 while oscillating sequentially from the first state to the fourth state. In this case, the arm massage unit 50 performs the oscillating operation, thereby performing the massage using a gripping operation and a twisting operation which imitate the motions of the fingers and the wrist of the human hand.

According to the above-described configurations, it is possible to provide the treatment unit and the massage machine which realize the treatment having the twisting operation added thereto.

### Action Pattern

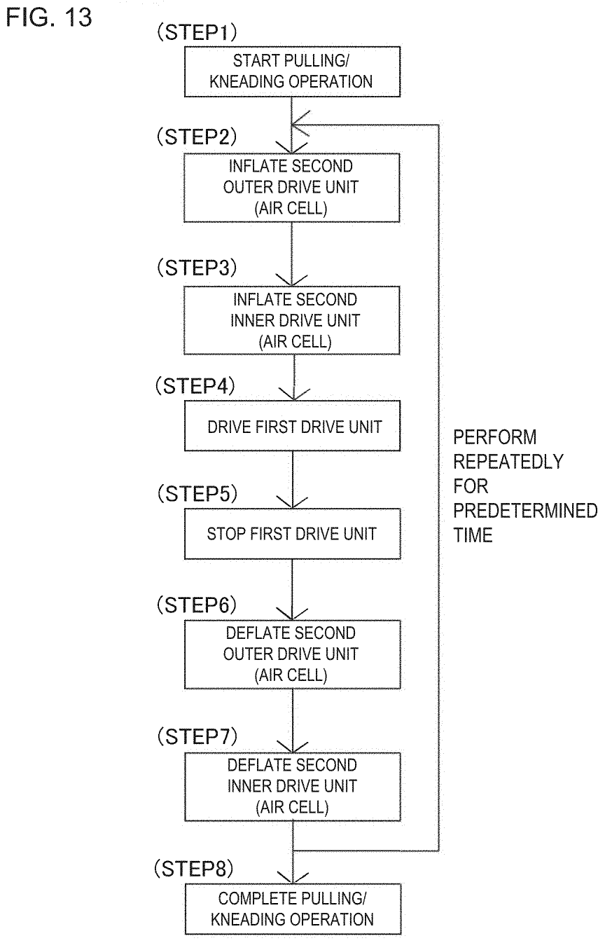

FIG. 13 is a flowchart illustrating an action pattern of the arm massage unit 50. The action pattern according to the present embodiment includes three operations such as an operation of driving the first drive unit 51 in a state where the second outer drive unit 52a and/or the second inner drive unit 52b are driven, an operation of changing the driving timings to be different from each other among the first drive unit 51, the second outer drive unit 52a, and the second inner drive unit 52b, and an operation of interlocking the drive timings with each other among the first drive unit 51, the second outer drive unit 52a, and the second inner drive unit 52b.

As illustrated in FIG. 13, the treatment target person starts a pulling/kneading operation (STEP 1). If the pulling/kneading operation starts, the air cell of the second outer drive unit 52a is inflated, and the outer first member 62a is moved in a direction closer to the treatment target person (STEP 2). Thereafter, the air cell of the second inner drive unit 52b is inflated, and the inner treatment unit 62b is moved in the direction closer to the treatment target person (STEP 3). In this state, the treatment target site of the treatment target person can be firmly gripped. In this state, the first drive unit 51 is driven (STEP 4). The first drive unit 51 is driven, thereby enabling the arm massage unit 50 to be driven in a direction extending along a direction facing the treatment target site of the treatment target person. That is, a three-dimensional massage operation can be performed. Thereafter, the first drive unit 51 stops to be driven (STEP 5). Then, the air cell of the second outer drive unit 52a is deflated, and the outer treatment unit 62a is moved in a direction away from the treatment target person (STEP 6). Thereafter, the air cell of the second inner drive unit 52b is deflated, and the inner treatment unit 62b is moved in the direction away from the treatment target person (STEP 7). After these operations are repeatedly performed for a predetermined time, the pulling/kneading operation is completed (STEP 8).

Since these operations are repeatedly performed for the predetermined time, it is possible to perform the massage reproducing the motions of the fingers and the wrist of the human hand for the treatment target site of the treatment target person.

The above-described action pattern is an example. An operation procedure of the first drive unit 51, the second outer drive unit 52a, and the second inner drive unit 52b is not limited as long as the pulling/kneading operation can be performed on the treatment target site of the treatment target person.

### Other Embodiments

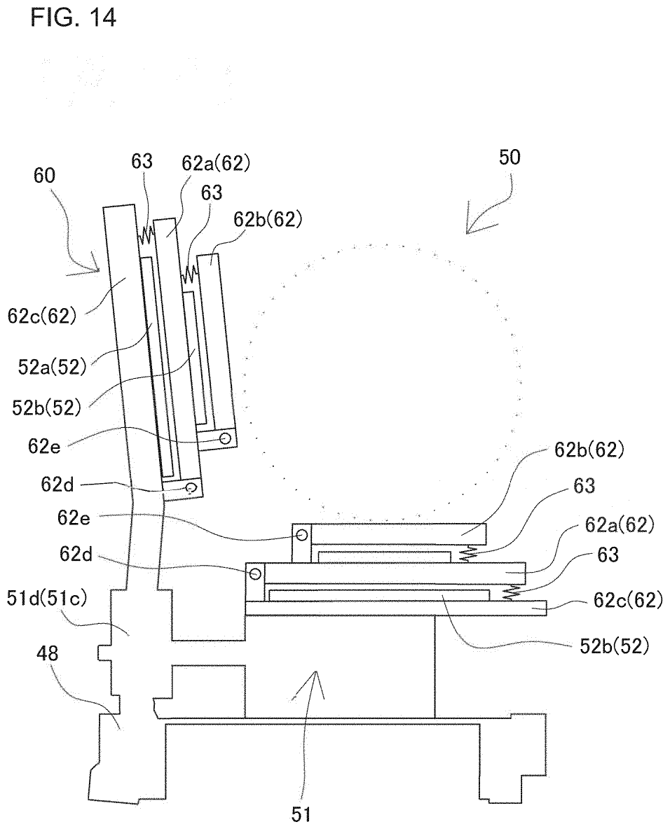

FIG. 14 is a schematic view of the arm massage unit 50 according to another embodiment of the present invention, and illustrates the arm massage unit 50 in which one of the treatment units 60 performs the massage in the upward-downward direction and the other of the treatment units 60 performs the massage in the rightward-leftward direction.

As illustrated in FIG. 14, one of the treatment units 60 (treatment unit 60 located outward) may be disposed so that the massage can be performed in the upward-downward direction, and the other of the treatment units 60 (treatment unit 60 located inward) may be disposed on the upper surface of the first drive unit 51 so that the massage can be performed in the rightward-leftward direction.

According to this configuration, the massage can be performed on the treatment target site of the treatment target person in two directions having mutually different vectors.

The other of the treatment units 60 may be attached to the first drive unit 51 via the conversion member 51c, similarly to one of the treatment units 60. In this manner, the other of the treatment units 60 can be driven. In addition, the massage unit 50 may be located on another body support unit such as the footrest 4. For example, since the massage unit 50 is located in the footrest 4, the massage can be performed on the lower limbs of the treatment target person in the two directions having mutually different vectors by the treatment plates 62c serving as the treatment unit 60 configuring the massage unit 50. In addition, since the massage unit 50 is located in the seat unit 2, the massage can be performed on the gluteal region or the femoral region of the treatment target person in the two directions having mutually different vectors by the treatment plates 62c serving as the treatment unit 60 configuring the massage unit 50. In addition, since the massage unit 50 is located in the backrest unit 3, the massage can be performed on the shoulders of the treatment target person in the two directions having mutually different vectors by the treatment plates 62c serving as the treatment unit 60 configuring the massage unit 50.

The embodiments disclosed in the present specification are examples, and the embodiments according to the present invention are not limited thereto. The embodiments can be appropriately modified within the scope not departing from the gist of the present invention. For example, the operation procedure of the first drive unit 51, the second outer drive unit 52a, and the second inner drive unit 52b may be changed. Specifically, the second outer drive unit 52a may be driven after the second inner drive unit 52b is driven. In this manner, compared to a case where the second inner drive unit 52b is driven after the second outer drive unit 52a is driven, the pulling/kneading operation can be performed on an outer side of the arm.

In addition, the massage unit 50 may be located on another body support unit such as the footrest 4. In a case where the massage unit 50 is located in the footrest 4, an arrangement is preferably adopted so that the lower limbs of the treatment target person can be pinched in the rightward-leftward direction by the treatment plates 62c serving as the treatment unit 60 configuring the massage unit 50. In this manner, the pulling/kneading operation can be performed on the lower limbs of the treatment target person.

In a case where the massage unit 50 is located in the seat unit 2, an arrangement is preferably adopted so that the gluteal region or the femoral region of the treatment target person can be pinched in the rightward-leftward direction by the treatment plates 62c serving as the treatment unit 60 configuring the massage unit 50. In this manner, the pulling/kneading operation can be performed on the gluteal region or the femoral region of the treatment target person.

In a case where the massage unit 50 is located in the backrest unit 3, an arrangement is preferably adopted so that the shoulders of the treatment target person can be pinched in the rightward-leftward direction and/or the forward-rearward direction by the treatment plates 62c serving as the treatment unit 60 configuring the massage unit 50. In addition, an arrangement is preferably adopted so that lateral body parts of the treatment target person can be pinched in the rightward-leftward direction by the treatment plates 62c serving as the treatment unit 60 configuring the massage unit 50. In this manner, the pulling/kneading operation can be performed on the shoulders, the lateral body parts, and the waist of the treatment target person.

The present invention is applicable to the massage machine including the massage unit which can reproduce the motion of the human hand and the motion of the human wrist.

Hereinbefore, the present invention has been described with reference to the embodiments, but the present invention is not limited thereto. It is obvious to those skilled in the art that various modifications, replacements, combinations and the like may be made, for example. It should be understood that the invention is not limited to the above-described embodiment, but may be modified into various forms on the basis of the spirit of the invention. Additionally, the modifications are included in the scope of the invention.

The contents of Japanese Application No. 2018-196484 filed on Oct. 18, 2018, including the specification, the claims and the drawings, are incorporated herein by reference in their entirety.

What is claimed is:

1. A massage machine comprising:
a massage unit configured to treat a treatment target person;
a first drive unit that drives the massage unit at least in a direction facing a treatment target site of the treatment target person; and
a control unit that controls driving of at least the first drive unit,
wherein the massage unit includes:
a treatment unit in an articulated structure with at least two or more joints, and
a second drive unit that drives the treatment unit at least in the direction facing the treatment target site, and
wherein the at least two or more joints are shifted from each other in a direction intersecting a longitudinal direction of the treatment target site.

2. The massage machine according to claim 1,
wherein a pair of the right and left massage units is disposed so as to pinch the treatment target site.

3. The massage machine according to claim 1,
wherein the first drive unit is capable of driving the massage unit in a direction extending along the treatment target site.

4. The massage machine according to claim 1,
wherein the first drive unit comprising:
a motor,
a drive shaft that transmits a rotational movement of the motor, and
a conversion member that converts the rotational movement of the drive shaft into an oscillating movement of the treatment unit.

5. The massage machine according to claim 1,
wherein the treatment unit comprises an outer treatment unit located relatively outward and an inner treatment unit located relatively inward, and
wherein the second drive unit comprises a second outer drive unit that drives the outer treatment unit, and a second inner drive unit that drives the inner treatment unit.

6. The massage machine according to claim 5,
wherein one of the joints comprises a biasing member that biases the treatment unit in a direction away from the treatment target site.

7. The massage machine according to claim 6,
wherein the biasing member is a tension spring.

8. The massage machine according to claim 5,
wherein the second outer drive unit and the second inner drive unit are capable of being independently driven.

9. The massage machine according to claim 1,
wherein the second drive unit is an air cell.

10. The massage machine according to claim 5,
wherein the second drive unit is an air cell.

11. The massage machine according to claim 8,
wherein the control unit further controls each driving of the second outer drive unit and the second inner drive unit, and
wherein the first drive unit is driven in a state where the second outer drive unit and/or the second inner drive unit are driven.

12. The massage machine according to claim 8,
wherein the control unit changes drive timings of the first drive unit, the second outer drive unit, and the second inner drive unit to be different from each other.

13. The massage machine according to claim 8,
wherein the control unit interlocks a drive timing of the first drive unit and a drive timing of the second drive unit with each other.
